(19) United States
(12) Patent Application Publication
(10) Pub. No.: US 2011/0299062 A1
(43) Pub. Date: Dec. 8, 2011

(54) DEVICE AND METHOD FOR DETECTING AND MEASURING WIND FOR AN AIRCRAFT

(75) Inventors: Guillermo Jenaro Rabadan, Toulouse (FR); Stephane Puig, Lauzerville (FR)

(73) Assignee: AIRBUS OPERATIONS (S.A.S.), TOULOUSE (FR)

(21) Appl. No.: 13/129,054

(22) PCT Filed: Nov. 2, 2009
(86) PCT No.: PCT/FR2009/001269

§ 371 Date: Aug. 25, 2011

(30) Foreign Application Priority Data
Nov. 5, 2008 (FR) 08 06157

(51) Int. Cl. G01P 3/36

(52) U.S. Cl. 356/28.5

(57) ABSTRACT

The invention relates to a device for detecting and measuring wind at the front of an aircraft, said device comprising a lidar for the cyclic measurement of wind speeds at least a couple of measuring points located at the same distance, so-called measuring distance, from the nose of the aircraft. The invention is characterised in that it is suitable for measuring wind speeds, at each cycle, by means of the lidar, at a plurality of couples of measuring points (1-12) located at different measuring distances (xp-2, xp-1, xp), the difference between the largest measuring distance and the smallest measuring distance being more than 100 metres. The invention also relates to a method for detecting and measuring wind, which can be implemented by the device according to the invention.

The present invention relates to a method and a device for detecting and measuring wind ahead of an aircraft.

Certain elements of the prior art or of the invention are described here in a spatial frame of reference related to the aircraft, referred to as aircraft frame of reference. Throughout the description, this aircraft frame of reference is defined in the usual way by a longitudinal direction of the aircraft, a transversal direction of the aircraft and a third direction, orthogonal to the other two, which by convention is referred to as vertical direction, even through it does not coincide—at least during flight—with the “vertical” of a terrestrial frame of reference such as defined by gravity. When any doubt is possible as to the frame of reference in question, the “vertical” of the terrestrial frame of reference is referred to as gravity direction.

Furthermore, the term “wind” designates the total air movement at a given point, as results from superposition of the mean air movement (laminar flow) and of the turbulence at that point. Turbulence is an agitation composed of complex, disordered and constantly changing movements.

Turbulence has detrimental effects on the aircraft. In particular, it may induce: vertical accelerations of the aircraft, capable of displacing objects or passengers in the cabin; a change of altitude levels, which in particular may cause a risk of collision with another aircraft; excess loads on the wing group; large roll moments; a sensation of discomfort in the cabin.

Three types of turbulence in particular are responsible for problems caused for the aircraft:
clear air turbulence, which results from wind shear; this turbulence, non-convective, appears at high altitude close to the jet streams, most often above mountains and more likely in winter,
convective turbulence, which appears inside or close to clouds; very severe turbulences may occur in storm clouds, where there coexist vertical currents in opposite directions that may reach tens of m/s. These phenomena are local and in general are visible (because of the presence of the clouds).
wake turbulence, created by the passage of an aircraft; the vortices generated by a heavy aircraft may induce large roll moments on a lighter aircraft.

Because they increase the loads on the wing group, turbulences make it necessary to reinforce the aircraft structure; consequently they have an impact on the weight thereof. In addition, turbulences fatigue the aircraft structure and therefore may limit its useful life or at the very least detract from its operational efficiency by necessitating frequent inspections of the structure and equipment items of the aircraft. Also, and above all, turbulences are the primary cause of injuries among passengers, not including fatal accidents.

The detection and measurement of turbulences as well as the employment of corresponding remedial actions therefore represent high stakes.

It is known that lidars (acronym for “Light Detection and Ranging”, meaning detection by light waves and telemetry) can be used to measure wind speeds ahead of the aircraft at a given distance therefrom, with a view to detecting the turbulences occurring at that distance. A lidar is an active transducer comprising a laser that emits a directed incident light beam, a telescope that collects the wave backscattered by the particles encountered by the incident beam, and processing means. The backscattered wave collected at the instant t=2d/c (where “c” denotes the speed of light) after emission of an incident beam corresponds to the wave backscattered by the atmospheric layer situated at the distance “d” from the lidar, referred to as sight distance. According to the Doppler effect, the speed of displacement of the said atmospheric layer in the sight direction of the lidar is deduced from the difference between the frequency of the incident beam and that of the backscattered wave.

To obtain the transversal and vertical components—in the aircraft frame of reference—of the wind speed at a given distance “d” from the aircraft (sight distance of the lidar) greater than 150 meters, FR 2870942 teaches the use of a single lidar capable of scanning in four directions (two vertical and two transversal). In the aircraft frame of reference, the measurement points sighted during this scan are situated on the same sphere centered on the lidar. Taking the (small) angular sectors scanned into account, it is considered by approximation that this scan forms a square in a plane situated at the distance “d” ahead of the aircraft. If the displacement of the aircraft during this scan is also disregarded, the vector difference between the velocity vectors (which are parallel to the sight direction of the lidar) obtained at two measurement points—forming a pair of measurement points—of the scan can be equated to the component, in the direction connecting the said measurement points, of the wind speed at a point of the atmosphere situated (at the instant of the measurement) between these two measurement points. Thus, for example, a pair of measurement points situated on the same vertical axis furnishes an evaluation of the vertical component of the wind speed at the point situated between these two measurement points. Likewise, a pair of measurement points situated on the same transversal axis furnishes an evaluation of the transversal component of the wind speed at the point situated between these two measurement points. Thus the device of FR 2870942 makes it possible to obtain an evaluation of the vertical component of the wind speed at one or more points situated at the distance “d” ahead of the aircraft, as well as an evaluation of the transversal component of the wind speed at one or more points situated at the distance “d” ahead of the aircraft.

According to the same principle, U.S. Pat. No. 5,724,125 describes a method for determining the wind speed at a target position situated at the altitude Z. The wind speed at the target position is calculated from measurements made on a scan cone and at the target altitude Z; in other words, the measurement points are all situated on the ellipse defined by the intersection between the scan cone and the target altitude Z.

Finally, FR 2883983 describes a device comprising three of four lidars and making it possible to measure wind speeds—in the respective sight direction of each lidar—at four measurement points situated ahead of the aircraft, at the same distance therefrom greater than 30 meters. In view of the weight and space requirement of a lidar, the use of such a device (comprising three or four lidars) is difficult to imagine, especially in a passenger transport aircraft.

Regardless of the device employed, the calculated wind speeds are generally used to establish evasive or control strategies. In particular, they are used to determine control instructions transmitted to the actuators of diverse mobile control surfaces (elevators/rudders, ailerons, slats, spoilers, flaps, etc.) of the aircraft. These control surfaces are therefore operated in a manner that reduces the loads to which the aircraft is subjected and the resulting problems.

To operate these control surfaces with good knowledge, it is advisable to evaluate the turbulences that the aircraft will actually encounter as precisely as possible. The known devices described hereinabove provide interesting items of information, but the precision and pertinence thereof may be deemed insufficient.

The invention is intended to remedy these disadvantages by proposing a device and a method for detecting and measuring wind, so that the turbulences occurring ahead of an aircraft can be determined with greater precision.

In a preferred version, the invention also is intended to make it possible to evaluate the risks of excitation of the aircraft or of a part thereof at a frequency corresponding to a rigid natural mode or a flexible natural mode of its structure.

To achieve this, the invention relates to a device for detecting and measuring wind, installed on board an aircraft, comprising a lidar for cyclic measurement of wind speeds at least one pair of measurement points situated at the same distance, referred to as measurement distance, from the nose of the aircraft. The device according to the invention is characterized in that it is adapted to measure, in each cycle, by means of the said lidar, wind speeds at a plurality of measurement points situated at different measurement distances, the difference between the largest measurement distance and the smallest measurement distance being greater than 100 meters.

The invention extends to the method for detecting and measuring executed by the device according to the invention. The invention also relates to a method for detecting and measuring wind, employed in an aircraft, wherein there are measured, cyclically, by means of a lidar, wind speeds at least one pair of measurement points situated at the same distance, referred to as measurement distance, from the nose of the aircraft. The method according to the invention is characterized in that there are measured, in each cycle, by means of the said lidar, wind speeds at a plurality of pairs of measurement points situated at different measurement distances, the difference between the largest measurement distance and the smallest measurement distance being greater than 100 meters.

Advantageously, the difference between the largest measurement distance and the smallest measurement distance (or in other words the distance separating the most distant pair of measurement points and the closest pair of measurement points of the aircraft) is greater than 200 meters, preferably greater than 500 meters, even greater than 800 meters.

Advantageously, wind speeds are measured at least three, preferably at least six measurement distances in each cycle, and the device according to the invention is adapted to achieve this.

The measurement of the wind at different distances from the nose of the aircraft and over a measurement interval greater than at least 100 meters makes it possible to increase the precision considerably. In fact, it is known that the precision of a lidar decreases with distance. By virtue of the invention, the measurement of the wind at a position initially situated at a great distance from the aircraft can be refined progressively as the aircraft approaches that position. In addition, the prior devices all rely on the hypothesis that the wind is steady over the duration dN (where “d” is the sight distance of the lidar and V the speed of displacement of the aircraft). This hypothesis is increasingly less realistic the greater the distance “d” and/or the more intense the turbulences. The device according to the invention makes it possible to obtain a plurality of measurements at the same given position of the atmosphere as the aircraft is moving. It is to be noted that the term “position” here denotes a point of the atmosphere (defined in a frame of reference not associated with the aircraft, such as a terrestrial frame of reference, contrary to the measurement points, which are defined in the aircraft frame of reference) or a zone of limited size around a point of the atmosphere, the diverse successive measurements taking place precisely at that point or in immediate proximity thereto. The device according to the invention therefore makes it possible to take into account the wind variations, at a given position, that occur between the first measurement performed at that position and the moment when the aircraft arrives at the said position.

In a preferred version, the device according to the invention is adapted to construct, in each cycle, at least one signal, referred to as wind profile signal, in a direction, referred to as excitation direction, on the basis of a plurality of measurements comprising the last or possibly the second-last measurement made at each of the measurement distances for at least one pair of measurement points aligned in the excitation direction, the said wind profile signal representing, at a given instant in an aircraft frame of reference, the component, in the said excitation direction, of the wind speed ahead of the aircraft according to the distance “x” in the longitudinal direction (this distance being expressed relative to the nose of the aircraft). In the method according to the invention, there is advantageously constructed, in each cycle, at least one wind profile signal such as defined in the foregoing.

It is to be noted that the number of pairs of measurement points taken into account for construction of a wind profile signal may vary if necessary from one signal to another (as explained hereinafter).

Preferably, the device according to the invention is adapted to construct:
one wind profile signal in the vertical direction in a median vertical longitudinal plane (symmetry plane) of the aircraft, the said signal representing, at a given instant, the vertical component of the wind speed in this median plane; it is established on the basis of measurements of wind speed at a pair of measurement points belonging to the said median plane at each measurement distance for which such a pair is acquired,
at least one wind profile signal in the vertical direction in a port plane of the aircraft, the said signal representing, at a given instant, the vertical component of the wind speed in a vertical plane in line with the port wing of the aircraft; it is established on the basis of measurements of wind speed at a pair of measurement points belonging to the said port plane at each measurement distance for which such a pair is acquired,
at least one wind profile signal in the vertical direction in a starboard plane of the aircraft, the said signal representing, at a given instant, the vertical component of the wind speed in a vertical plane in line with the starboard wing of the aircraft; it is established on the basis of measurements of wind speed at a pair of measurement points belonging to the said starboard plane at each measurement distance for which such a pair is acquired,
at least one wind profile signal in the transversal direction, representing, at a given instant, the transversal component of the wind speed in a plane, referred to as horizontal plane, orthogonal to the vertical direction; this signal is established on the basis of measurements of wind speed at a pair of measurement points belonging to the said horizontal plane at each measurement distance for which such a pair is acquired.

For at least one—and preferably for each—constructed wind profile signal, the device according to the invention is also preferably adapted to process this wind profile signal so as to determine a frequency content thereof.

The frequency, at a given distance x, of such a wind profile signal, is representative of the frequency at which the aircraft will be excited in the excitation direction (of the said profile) when it arrives at the position in the atmosphere corresponding to that given distance x. The determination of the frequency content of this signal therefore makes it possible to estimate the frequencies at which the aircraft tends to be excited relative to its movement. This information, which no known prior device is capable of providing, proves extremely useful in choosing the control surfaces to be actuated and the corresponding actuation parameters.

In particular, it is possible from now on to know, for example, if the aircraft is likely to be excited in a rigid natural mode or a flexible mode of its structure. In practice, the determination of the frequency content is therefore preferably oriented according to the frequencies that are to be detected (or in other words, according to one or more natural modes of the aircraft).

Advantageously, the device for detecting and measuring wind according to the invention is adapted to process a wind profile signal so as to determine if it or part thereof contains at least one frequency included in at least one predefined frequency range. Preferably, the device is adapted:
to process the wind profile signal so as to determine if it or part thereof contains at least one frequency close to a rigid natural mode of the aircraft. For example, in the case of a wind profile signal in the vertical direction, the device is advantageously adapted to process the said signal so as to determine if it or part thereof contains at least one frequency close to a rigid natural mode of the aircraft known by the term incidence oscillation frequency; thus the processing is advantageously adapted to make it possible to determine if the wind profile signal contains at least one frequency lower than 0.5 Hz (the incidence oscillation frequency of an aircraft generally being on the order of 0.2 Hz to 0.4 Hz);
alternatively, or preferably in combination, to process the wind profile signal so as to determine if it or part thereof contains at least one frequency close to a flexible natural mode of the aircraft and especially of its wing group, of its fuselage or else of its stabilizers (vertical and horizontal). For example, in the case of a wind profile signal in the vertical direction, and for an aircraft whose wing group has a natural mode of bending oscillation on the order of 0.6 Hz to 0.7 Hz, the processing advantageously is adapted to make it possible to determine if a part of the wind profile signal corresponding to the distance range of [0; 400 m] or [0; 2 s] contains at least one frequency above 0.5 Hz. According to another example, for an aircraft whose wing group has a natural mode of bending oscillation on the order of 1.1 Hz to 1.5 Hz, the processing advantageously is adapted to make it possible to determine if a part of the wind profile signal in the vertical direction corresponding to the distance range of [0; 200 m] or [0; 1 s]—or possibly of [200 m; 400 m] or [1 s; 2 s]—contains at least one frequency higher than or equal to 1 Hz. According to another example, and in order to evaluate the risks to which the aircraft fuselage is exposed, the processing advantageously is adapted to make it possible to determine if a part of the wind profile signal in the vertical direction corresponding to the distance range of [0; 200 m] or [0; 1 s]—or else of [0; 100 m] or [0; 0.5 s] or even of [100 m; 200 m] or [0.5 s; 1 s]—contains at least one frequency higher than or equal to 2.5 Hz (or even higher than or equal to 3 Hz, depending on the aircraft).

The power of a lidar usually determines its sight distance. The lidar of the device according to the invention is therefore preferably chosen according to the maximum desired measurement distance. Nevertheless, if this maximum distance is very large, it is also possible to use a lidar of power lower than that required and capable of compensating for its lack of power by delivering incident light pulses grouped in packets. In this way the on-board power necessary for operation of the device according to the invention is limited.

In a preferred version, the device according to the invention is adapted to measure wind speeds at a plurality of measurement points situated in the same sight direction, at different measurement distances, on the basis of the same incident light pulse or of the same packet of grouped incident light pulses. For this purpose its lidar comprises, for example, a telescope equipped with a shutter controlled so that it can be opened successively at different times corresponding to the different measurement distances after each incident light pulse or each packet delivered. It is to be noted in this preferred version that the device according to the invention may be adapted to acquire, from the same incident light pulse or from the same packet of grouped pulses, all of the measurement points situated at the same sight distance or only some of these measurement points. In this second case, the device is further adapted to deliver several incident light pulses or several packets of grouped pulses for each sight direction.

This preferred version does not exclude the possibility of providing a device for detecting and measuring wind adapted to deliver an incident light pulse (or a packet of grouped pulses, as the case may be) for each measurement point. In this case, the device preferably has variable power and means for adjusting the power, for each delivered incident light pulse, according to the measurement distance of the corresponding measurement point. It is also possible to use a lidar of fixed power, preferably chosen according to the maximum measurement distance, with the advantage of reducing the measurement error for small measurement distances—or in other words closer to the aircraft.

Advantageously, the device according to the invention is adapted to make it possible to define each measurement distance not only in units of length, for example in meters or feet, but also in units of time, preferably in seconds. For this purpose it advantageously comprises calculating means capable of calculating the distance (expressed in units of length) between the lidar and each measurement point, on the basis of the measurement distance expressed as time and of data representative of the flying speed of the aircraft, furnished in real time by a processing unit of the aircraft. These calculating means may be integrated into the said processing unit of the aircraft or into a processing unit specific to the lidar.

Advantageously, the device according to the invention is adapted to measure wind speeds up to measurement distances reaching to 4 seconds or 800 meters, or else 5 seconds or 1000 meters, possibly even 7 seconds or 1400 meters. In practice, the maximum measurement distance of the device according to the invention is chosen according to the lowest frequency that must be detected.

Advantageously, the device according to the invention is adapted to measure wind speeds at least six measurement points at each measurement distance, which points form—at each measurement distance—three pairs, referred to as vertical pairs, of measurement points aligned in the vertical direction, and at least one pair, referred to as transversal pair, of measurement points aligned in the transversal direction. Preferably, at each measurement distance or at only some of them, the device according to the invention is adapted to measure wind speeds at least ten measurement points, forming five vertical pairs of measurement points.

Advantageously, the device according to the invention is adapted to measure wind speeds at least one measurement distance close to the aircraft, for example at less than 250 ms or at 50 m and preferably at less than 150 ms or at 30 m, in order to offer a device alternative to the anemometer of the aircraft.

Advantageously, the device according to the invention is adapted to measure wind speeds at measurement distances positioned progressively closer to one another in the direction of the aircraft, or in other words progressively farther apart from one another with increasing distance from the aircraft. In other words, if “x” denotes the measurement distance and “Δx” denotes the distance between two successive measurement distances, Δx advantageously increases with x. For example, Δx increases exponentially.

Advantageously, the device for detecting and measuring wind according to the invention is connected to a processing unit of the aircraft, which in turn is connected to aircraft transducers chosen from among: an inertial reference unit capable of measuring the vertical speed Vz of the aircraft relative to the ground, the angle φ of inclination of the wings of the aircraft relative to the horizontal, the trim angle θ of the aircraft and the pitch speed q of the aircraft; an anemometric sensor, usually used to measure the speed Vtas of the aircraft relative to the air mass in which the aircraft is moving; an incidence sensor, usually used to measure the angle of incidence α of the aircraft; a sideslip sensor, usually used to measure the sideslip angle β of the aircraft. The device according to the invention and one or more of the aforesaid transducers may then be used advantageously to achieve hybridization of the signal in order to improve the precision of the measurement.

The invention extends to an aircraft comprising at least one—and preferably only one—device for detecting and measuring wind according to the invention.

Other details and advantages of the present invention will become apparent upon reading the description hereinafter, which refers to the attached schematic drawings and is based on a preferred embodiment, provided by way of non-limitative example. In these drawings:

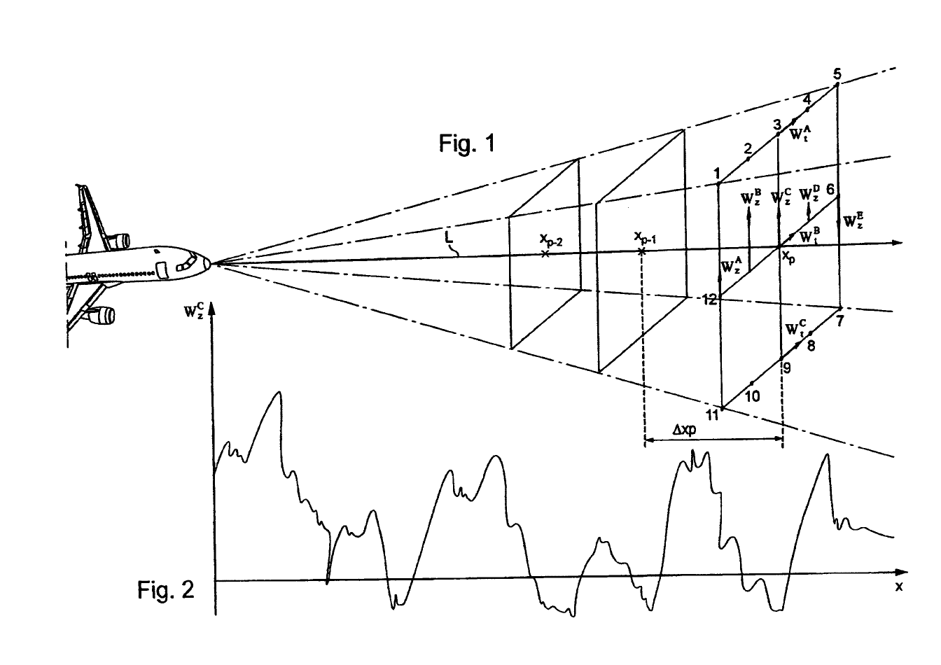

FIG. 1 is a schematic perspective view of an aircraft and of the environment ahead of it, wherein there are indicated measurement points sighted by a device according to the invention,

FIG. 2 is a diagram representing a wind profile signal constructed by means of a device according to the invention.

The aircraft illustrated in FIG. 1 is equipped with a device for detecting and measuring wind, which device, according to the invention, comprises a lidar and is adapted to measure wind speeds at a plurality of pairs of measurement points situated at different distances, referred to as measurement distances, from the nose of the aircraft. Advantageously, this device comprises a single lidar and therefore has limited weight and space requirement. In the usual manner, this lidar comprises a laser capable of emitting directed incident light pulses individually or grouped in packets, and a telescope that collects the wave backscattered by the particles encountered by the incident light beam.

The device according to the invention also comprises information technology processing means (software and hardware) with a microprocessor or microprocessors.

The telescope and the processing means are advantageously adapted to collect, for each incident light pulse or for each packet of grouped pulses emitted by the laser, the wave backscattered at different times tₙ counting from emission of the incident light pulse, each time tₙ corresponding to a measurement distance xₙ according to the relation tₙ=2xₙ/c (where c denotes the speed of light). Preferably, the distance Δx between two consecutive measurement distances increases with x, for example exponentially. The laser advantageously has a wavelength situated in the ultraviolet, thus offering high resolution. Furthermore, it has a power adapted to make it possible to measure wind speeds at a maximum measurement distance between 500 m and 1500 m, for example on the order of 1000 m or 5 s. Nevertheless, it may have a lower power, in which case it delivers incident light pulses grouped in packets, in order to compensate for power that a priori is insufficient (for large measurement distances).

The device according to the invention additionally comprises means for adjusting the sight direction of its lidar, making it possible to modify the sight direction between two emitted incident light pulses (or between two packets). In the illustrated example, the device is programmed so as to emit incident light pulses in twelve sight directions. In other words, for certain measurement distances xₙ at least, the device is capable of measuring wind speeds at twelve measurement points 1 to 12.

The measurement points situated at the same measurement distance belong to the same sphere centered on the lidar in the aircraft frame of reference. As an approximation, they are represented in FIG. 1 as belonging to the same plane, referred to as measurement plane, orthogonal to the longitudinal direction L of the aircraft and situated at a distance from the nose of the aircraft equal to the measurement distance. For clarity, only three measurement planes, situated at measurement distances xₚ₋₂, xₚ₋₁ and xₚ, have been represented in FIG. 1; in addition, they have been intentionally spaced apart from one another for better legibility.

In the illustrated measurement plane situated at the measurement distance xₚ:
measurement points 1 and 11 form a vertical pair of measurement points that yields, by vector difference of the speeds measured at these points, an evaluation of the vertical component W_{z}^{A} of the wind speed at a position of the atmosphere situated in line with—in longitudinal direction—a central or distal (meaning close to the tip) portion of the starboard wing of the aircraft,
measurement points 2 and 10 form a vertical pair of measurement points that yields, by vector difference, an evaluation of the vertical component WP of the wind speed at a position of the atmosphere situated in line with—in longitudinal direction—a proximal (meaning close to the root) or central portion of the starboard wing of the aircraft,
measurement points 3 and 9 form a vertical pair of measurement points that yields, by vector difference, an evaluation of the vertical component W_{z}^{C} of the wind speed at a position of the atmosphere situated on a central longitudinal axis of the aircraft, or in other words in line with—in longitudinal direction—the nose and the fuselage of the aircraft,
measurement points 4 and 8 form a vertical pair of measurement points that yields, by vector difference, an evaluation of the vertical component W_{z}^{D} of the wind speed at a position of the atmosphere situated in line with—in longitudinal direction—a proximal (meaning close to the root) or central portion of the port wing of the aircraft,
measurement points 5 and 7 form a vertical pair of measurement points that yields, by vector difference, an evaluation of the vertical component W_{z}^{E} of the wind speed at a position of the atmosphere situated in line with—in longitudinal direction—a central or distal (meaning close to the tip) portion of the port wing of the aircraft,
measurement points 1 and 5, or measurement points 2 and 4, form a transversal pair of measurement points that yields, by vector difference, an evaluation of the transversal component Wₜ^{A} of the wind speed at a position of the atmosphere situated in a median vertical longitudinal plane (symmetry plane) of the aircraft, above the central longitudinal axis of the aircraft, measurement points 6 and 12 form a transversal pair of measurement points that yields, by vector difference, an evaluation of the transversal component Wₜ^{B} of the wind speed at a position of the atmosphere situated on the central longitudinal axis of the aircraft, or in other words in line with the nose and the fuselage of the aircraft,
measurement points 11 and 7, or measurement points 10 and 8, form a transversal pair of measurement points that yields, by vector difference, an evaluation of the transversal component Wₜ^{C} of the wind speed at a position of the atmosphere situated in the median vertical longitudinal plane of the aircraft, below the central longitudinal axis of the aircraft.

Measurement points 1 of the different measurement planes are aligned in a first sight direction of the lidar; they form a first series of measurement points. Similarly, measurement points 2 of the different measurement planes are aligned in a second sight direction of the lidar and form a second series of measurement points, and so on. Preferably, each series of measurement points comprises at least four measurement points distributed over the distance range of [0; 200 m] or [0; 1 s] and at least three other measurement points distributed over the distance range of [200 m; 1000 m] or [1 s; 5 s]. The number of measurement points per series and their distribution may vary from one series to another. For example, the series of measurement points 3 and 9, which yield evaluations of the vertical component W_{z}^{C} of the wind speed in line with the fuselage of the aircraft, advantageously comprise a relatively high number of measurement points, of which at least eight (and preferably at least 16) measurement points are distributed over the distance range of [0; 200 m] or [0; 1 s] and at least six (and preferably at least 12) other measurement points are distributed over the distance range of [200 m; 1000 m] or [1 s; 5 s]. On the other hand, the series of measurement points 2, 10, 4 and 8, for example, may comprise a smaller number of measurement points, especially in the distance range of [200 m; 1000 m] or [1 s; 5 s].

The device according to the invention preferably operates as follows. A first light pulse is emitted in the first sight direction passing through measurement points 1; this pulse makes it possible to acquire the frequency of the wave backscattered at measurement point 1 for each measurement distance (of the series) and therefore to measure the wind speed in the first sight direction at each measurement point 1. The adjustment means are then actuated to modify the sight direction of the lidar, so that it points toward measurement points 2. A second light pulse is then emitted in the second sight direction (passing through measurement points 2); this pulse makes it possible to acquire the frequency of the backscattered wave for the series of measurement points 2 and therefore to measure the wind speed in the second sight direction for each of the said measurement points 2. The adjustment means are then actuated to modify the sight direction of the lidar, so that it points toward measurement points 3, then a third light pulse is emitted in this new—third—sight direction, and so on for all sight directions.

The acquisition of measurements for the twelve series of measurement points constitutes one measurement cycle, which is repeated indefinitely in iterative manner. By way of example, the device according to the invention advantageously is adapted to perform a complete measurement cycle in less than 60 ms.

During and for each measurement cycle, the processing unit of the device for detecting and measuring wind calculates, by vector difference, the vertical component W_{z}^{A} of the wind speed in each measurement plane on the basis of speeds measured for measurement points 1 and 11 of the said measurement plane. In analogous manner, the vertical component W_{z}^{B} of the wind speed in each measurement plane is calculated on the basis of speeds measured for measurement points 2 and 10 of the said measurement plane, and so on for all of the vertical components W_{z}^{C} to W_{z}^{E}. The processing means also calculate, by vector difference, the transversal component Wₜ^{A} of the wind speed in each measurement plane on the basis of speeds measured for measurement points 1 and 5 (or 2 and 4) of the said measurement plane, and in the same way the transversal component Wₜ^{B}—respectively Wₜ^{C}—of the wind speed in each measurement plane on the basis of speeds measured for measurement points 12 and 6—respectively 11 and 7 (or 10 and 8)—of the said measurement plane.

Alternatively or in combination, the processing means of the device for detecting and measuring wind may if necessary calculate wind speed components on the basis of speeds measured for different measurement cycles (successive or otherwise) and/or for measurement points situated at different measurement distances (consecutive or otherwise), in order to take into account the distance traveled by the aircraft in the terrestrial frame of reference in the course of one measurement cycle. For example, the processing means may be programmed to calculate the vertical component W_{z}^{A} of the wind speed at a distance xᵢ for cycle j on the basis, on the one hand, of the speed measured for measurement point 11 at the distance xᵢ for cycle j−1, and, on the other hand, of the speed measured for measurement point 1 at the distance for cycle j (subject to the reservation that the direction of “rotation” of the measurement cycle is that described above). According to another example, especially in the case in which the speed of the aircraft is high and, for example, is greater than a predefined threshold, the processing means may be programmed to calculate the vertical component W_{z}^{C} of the wind speed at a distance for cycle j on the basis, on the one hand, of the speed measured for measurement point 3 at the distance xᵢ₊₁ for cycle j−1, and, on the other hand, of the speed measured for measurement point 9 at the distance for cycle j.

Some or all of the vertical components W_{z}^{A} to W_{z}^{E} and transversal components Wₜ^{A} to Wₜ^{C} calculated in this way are used, by the processing means, to construct one or more wind profile signals. Each wind profile signal represents, at a given instant, the component in an excitation direction (vertical or transversal) of the wind speed ahead of the aircraft according to the distance x.

For example, the set of components W_{z}^{C} calculated for the different measurement distances and for a given measurement cycle is used to construct a wind profile signal in the vertical direction in the median plane of the aircraft. FIG. 2 illustrates this signal which, in the example, is a continuous signal (which may nevertheless be in stages) obtained by interpolation on the basis of the calculated components W_{z}^{C}. This signal makes it possible to predict the excitations in pitch of the aircraft.

By analogy, the set of components W_{z}^{B} calculated for the different measurement distances and for a given measurement cycle may be used to construct a wind profile signal in the vertical direction in a starboard plane of the aircraft. The set of components W_{z}^{D} calculated for the different measurement distances and for a given measurement cycle may be used to construct a wind profile signal in the vertical direction in a port plane of the aircraft. These two signals are useful for the determination of roll moments to which the aircraft will be subjected.

Finally, the set of components Wₜ^{B} calculated for the different measurement distances and for a given measurement cycle can be used to construct a wind profile signal in the transversal direction in a horizontal plane of the aircraft, transecting its fuselage. This signal makes it possible to evaluate the risks of sideslip of the aircraft.

The other calculated speed components may be used analogously to construct other wind profile signals if necessary or to refine the preceding signals in certain situations.

Each wind profile signal constructed in this way characterizes the atmospheric environment of the aircraft at a given instant and is continually updated at least every 60 ms (duration of one measurement cycle).

In addition, the processing means of the device according to the invention are advantageously adapted for processing at least one wind profile signal, and for example the wind profile signal W_{z}^{C}, so as to determine its frequency content. It is to be noted that the processing steps applied to determine this frequency content depend on the frequencies to be detected and therefore on the excitation direction in question, or in other words the wind signal profile being analyzed. The description hereinafter concerns the signal W_{z}^{C} (vertical excitation direction, wind in the median plane of the aircraft).

This wind profile signal W_{z}^{C} makes it possible in particular to detect if aircraft pitch phenomena (which generate great discomfort for persons) are likely to occur. For this purpose, the processing means are adapted to investigate whether the wind profile signal W_{z}^{C} contains at least one frequency close to the incidence oscillation frequency of the aircraft. Such an incidence oscillation frequency is generally on the order of 0.3 Hz. To be able to observe such a frequency, it is useful to have available a signal covering a period of at least 3.4 s, and for example on the order of 4 s. It is for this reason that, on the one hand, the lidar preferably has a maximum sight distance is some 5 s or 1000 m and, on the other hand, at least four—and preferably at least eight—measurement points are provided over the distance range of [0; 5 s] or [0; 1000 m] or, for reasons explained below, over the distance range of [1 s; 5 s] or [200 m; 1000 m]. The pitch phenomena are advantageously countered by means of one or more mobile control surfaces of the aircraft tail. Such mobile surfaces have an indirect effect on the loads to which the fuselage and wing group of the aircraft are subjected. It is therefore preferable to detect the corresponding turbulences as soon as possible, or in other words at a great distance from the nose of the aircraft. Consequently, it is preferable to analyze the part of the wind profile signal corresponding to the distance range of [1 s; 5 s] or [200 m; 1000 m]. In practice, the processing means advantageously process the entirety of the signal W_{z}^{C} or the aforesaid signal part so as to determine if that signal or that part contains frequencies below 0.5 Hz.

The wind profile signal W_{z}^{C} also makes it possible to detect the presence of turbulences that could jeopardize the structure of the aircraft, and in particular its wing group. For this purpose, the processing means of the device according to the invention are advantageously adapted to detect whether the wind profile signal W_{z}^{C} contains at least one frequency close to a natural mode of bending oscillation of the aircraft wings. The first natural bending mode of an aircraft wing group is generally situated between 1.1 Hz and 1.5 Hz. To observe such a frequency, it is sufficient to analyze the wind profile signal over a period of 0.67 s to 1 s. Furthermore, the effects of such turbulence are advantageously countered by means of one or more mobile control surfaces of the wing group. Such mobile surfaces have relatively high deflection speeds and, above all, exert a direct and immediate effect on the loads to which the wing group is subjected. Provision may therefore be made to analyze the wind profile signal in the proximity of the aircraft nose, a zone where the signal obtained is more precise. In practice, the processing means preferably process the part of the wind signal profile W_{z}^{C} corresponding to the distance range of [0; 1 s] or [0; 200 m], so as to determine if this contains frequencies above 1 Hz.

It is to be noted that the wing group of certain aircraft has a natural bending mode between 0.6 and 0.7 Hz. For these aircraft, the processing means are advantageously adapted to process the part of the wind profile signal corresponding to the distance range of [0; 2 s] or [0; 400 m], so as to determine if this contains frequencies above 0.5 Hz.

The signal processing steps described in the foregoing may be achieved in diverse ways.

According to a first embodiment, the processing means comprise at least one low-pass filter and at least one high-pass filter. The low-pass filter makes it possible to attenuate or even eliminate the high frequencies and therefore to detect the low frequencies; conversely, the high-pass filter makes it possible to detect the high frequencies. The said filters are chosen according to the frequency ranges to be detected. As an example, it is advantageous to use, on the one hand, a low-pass filter whose cutoff frequency (frequency above which the frequencies are attenuated or eliminated) is substantially equal to 0.5 Hz, and, on the other hand, a high-pass filter whose cutoff frequency (frequency below which the frequencies are attenuated or eliminated) is substantially equal to 0.5 Hz or to 1 Hz.

According to a second embodiment, the processing means are adapted to evaluate a mean period of the wind profile signal over the signal part to be processed (or in other words, over the interval of [0; 400 m] or [0; 2 s] or the interval of [0; 200 m] or [0; 1 s] or the entirety of the signal, depending on the frequency range to be detected), according to the number of passes of the said signal through the value zero over this part. The inverse of this mean period evaluated in this way yields a mean frequency of the signal over the processed part.

According to a third embodiment, the processing means are adapted to estimate a mean standard deviation of the wind profile signal over the signal part to be processed, on the basis of the maximum amplitude of the signal over this part and of a constant coefficient predetermined empirically and statistically, which coefficient represents the mean ratio between the standard deviation and the maximum amplitude of a wind profile signal. They moreover are adapted to compare the standard deviation estimated in this way with a range of standard deviations corresponding to the frequency range to be detected, which range of standard deviations is determined beforehand by integration of part of a Von Karman or Kolmogorov spectrum, which represents an energy density according to the spatial frequency and is pre-established empirically and statistically.

The processing means may be adapted to process other wind profile signals in similar manner.

The invention may be the object of numerous variants relative to the illustrated embodiment, provided these variants fall within the scope defined by the claims.

1. A device for detecting and measuring wind, installed on board an aircraft, comprising:
a lidar for cyclic measurement of wind speeds at least one pair of measurement points situated at the same distance, referred to as measurement distance, from a nose of the aircraft,
wherein the device is adapted to measure, in each cycle, by means of the said lidar, wind speeds at a plurality of measurement points situated at different measurement distances, the difference between the largest measurement distance and the smallest measurement distance being greater than 100 meters.

2. A device according to claim 1, wherein the difference between the largest measurement distance and the smallest measurement distance is greater than 500 meters.

3. A device according to claim 1, wherein the device is adapted to measure wind speeds at more than three measurement distances in each cycle.

4. A device according to claim 1, wherein the device is adapted to construct, in each cycle, at least one signal, referred to as wind profile signal, in a direction, referred to as excitation direction, on the basis of a plurality of measurements comprising the last or possibly the second-last measurement made at each of the measurement distances for at least one pair of measurement points aligned in the excitation direction, the said wind profile signal representing, at a given instant in an aircraft frame of reference, the component, in the said excitation direction, of the wind speed ahead of the aircraft according to the distance “x” in the longitudinal direction of the aircraft.

5. A device according to claim 4, wherein, for at least one constructed wind profile signal, the device is adapted to process this wind profile signal so as to determine its frequency content.

6. A device according to claim 5, wherein the device is adapted to process the said wind profile signal so as to determine if it or a part thereof contains at least one frequency included in at least one predefined frequency range.

7. A device according to claim 1, wherein the device is adapted to measure wind speeds at a plurality of measurement points situated in the same sight direction, at different measurement distances, on the basis of the same incident light pulse or of the same packet of grouped incident light pulses.

8. A device according to claim 1, wherein the device is adapted to measure wind speeds at least six measurement points at each measurement distance, which points form three pairs, referred to as vertical pairs, of measurement points aligned in the vertical direction, and at least one pair, referred to as transversal pair, of measurement points aligned in the transversal direction.

9. A device according to claim 1, wherein the device is adapted to measure wind speeds up to measurement distances reaching 4 seconds or 800 meters.

10. A device according to claim 1, wherein the device is adapted to measure wind speeds at measurement distances progressively closer to one another in the direction of the aircraft.

11. An aircraft, wherein the aircraft comprises a device for detecting and measuring wind according to claim 1.

12. A method for detecting and measuring wind, employed in an aircraft, wherein there are measured, cyclically, by means of a lidar, wind speeds at least one pair of measurement points situated at the same distance, referred to as measurement distance, from the nose of the aircraft, comprising:
measuring, in each cycle, by means of the said lidar, wind speeds at a plurality of pairs of measurement points situated at different measurement distances, the difference between the largest measurement distance and the smallest measurement distance being greater than 100 meters.

13. A method according to claim 12, wherein the difference between the largest measurement distance and the smallest measurement distance is greater than 500 meters.

14. A method according to claim 12, wherein there is constructed, in each cycle, at least one signal, referred to as wind profile signal, in a direction, referred to as excitation direction, on the basis of a plurality of measurements comprising the last or possibly the second-last measurement made at each of the measurement distances for at least one pair of measurement points aligned in the excitation direction, the said wind profile signal representing, at a given instant in an aircraft frame of reference, the component, in the said excitation direction, of the wind speed ahead of the aircraft according to the distance “x” in the longitudinal direction of the aircraft.

15. A method according to claim 14, wherein, for at least one constructed wind profile signal, this wind profile signal is processed so as to determine its frequency content.
